(19) United States
(12) Patent Application Publication
(10) Pub. No.: US 2025/0359689 A1
(43) Pub. Date: Nov. 27, 2025

(54) MUSEUM DISPLAY CASE WITH GLASS SIDE WALLS AND SLIDINGLY OPENABLE UPPER DOOR

(71) Applicant: GOPPION S.P.A., Milano (IT)

(72) Inventor: Alessandro GOPPION, MILANO (IT)

(21) Appl. No.: 19/218,249

(22) Filed: May 24, 2025

(30) Foreign Application Priority Data
May 27, 2024 (IT) 102024000012022

(51) Int. Cl. A47F 3/12; A47F 3/00; E06B 3/46

(52) U.S. Cl. CPC A47F 3/125; E06B 3/4663; A47F 3/005

(57) ABSTRACT

A museum display case with a fixed case formed by fixed glass walls surmounted by an upper openable glass door. The openable glass door is slidingly openable with respect to the fixed case. The fixed glass walls and the openable glass door have, with respect to the display case, respective inner faces and outer faces connected by peripheral edges. The museum display case has two linear sliding guides between the openable glass door and the fixed case. The linear sliding guides are applied, on one side, on the inner face of the openable glass door near opposite peripheral edges of the openable glass door and, on the other side, on the peripheral edge of two opposite fixed glass walls. The linear sliding guides have dimensions corresponding to the thickness of the fixed glass wall to which they are applied.

### CROSS-REFERENCE TO RELATED APPLICATIONS

The present application claims priority of Italian Application No. 102024000012022 filed on May 27, 2024, the contents of which are incorporated herein by reference in their entirety.

### FIELD

The present disclosure relates to a museum display case, i.e. a display case designed and built for storing and displaying, in a protected environment, cultural assets, such as works of art, historical exhibits and the like, within the context of an exhibiting environment such as a museum, an exhibition or the like. The term display case alone will be used below for the sake of brevity, although it still means a museum display case.

### Definitions

The term protected environment means here and hereinafter an environment whose access is prevented to unauthorised personnel, in order to avoid theft of or damage to the exhibits, and wherein preferably the atmosphere can be controlled, by monitoring one or more parameters including temperature, humidity, dust content, pollutant content, in order to maintain the intended conservation conditions of the exhibits.

### BACKGROUND

This type of display case must therefore meet various requirements, in relation to conservation and integrity of the objects displayed. Furthermore, these display cases must of course ensure the best visibility for the objects displayed.

In order to improve visibility, display case manufacturers try as far as possible to use transparent materials—typically glass—for the walls of the display cases. In addition to guaranteeing the best visibility of the objects on display, the extensive use of glass is often desired by display case designers because the transparency of the material allows the objects on display to be given maximum prominence, without the observer being distracted by elements other than the objects on display in the display case.

However, it is not possible to use only glass, unless the display case can be made as a bell-shaped display case, i.e. wherein the vertical side walls and the horizontal upper wall are all made of glass and made integral with each other; the opening of such a display case is achieved by raising the entire bell formed by the glass walls integral with each other with respect to the fixed base. However, this type of display case is only suitable for a small display case. Otherwise, the display case must have metal mechanisms to allow the opening and closing of at least one openable door: guides, slides, hinges, articulated arms or other similar mechanisms.

For example, in the case of so-called table-top display cases, in which the objects on display are viewed mainly through the transparent upper wall, the openable door is formed by the upper wall itself, which, for the opening, can be hinged along one side, so that it can be opened (even completely) by raising this wall, or it can be mounted on sliding guides that allow it to be opened, even if only partially. Hinges and guides, however, have a non-negligible visual impact, which penalises the display case.

### SUMMARY

The present disclosure provides a display case of this type, wherein the opening mechanism is so inconspicuous as to be substantially invisible, as set forth in the specification and claims of the present application.

In particular, this museum display case comprises a fixed case formed by fixed glass side walls surmounted by an upper openable glass door, which is slidingly openable with respect to the fixed case, wherein the fixed glass walls and the openable glass door have—with respect to the display case—respective inner faces and outer faces connected by peripheral edges, wherein the museum display case comprises two linear sliding guides between the openable glass door and the fixed case, wherein the linear sliding guides are applied, on one side, on the inner face of the openable glass wall at opposite peripheral edges of the openable glass wall, on the other side, on the peripheral edge of two opposite fixed glass walls, wherein the linear sliding guides have dimensions corresponding to the thickness of the fixed glass wall to which they are applied.

Thus, the guides have a minimal, substantially negligible, visible impact, as they are only small appendages of the side walls, close to the corners of the display case and coplanar with the faces of the fixed glass walls, and therefore in a practically invisible position, especially when observing the contents of the display case from above, as is the case with this type of table-top display cases.

Preferably, each of the two linear sliding guides comprises a fixed semi-guide fixed to the peripheral edge of one of the fixed glass walls and a movable semi-guide fixed to the inner face of the openable glass door.

Preferably, the fixed semi-guide comprises rolling rollers while the movable semi-guide comprises a contact track resting on the rolling rollers. Alternatively, the fixed semi-guide and the movable semi-guide comprise respective low sliding friction contact tracks. The presence of rolling rollers is preferable, due to the sliding smoothness, even if the openable glass door has considerable weight. The solution with low sliding friction contact tracks is constructively simpler, and is particularly suitable for relatively small display cases, wherein the openable glass door has a low weight.

Preferably, the fixed semi-guide is formed by a first profile, comprising a lower wedge fixed below to the peripheral edge of the fixed glass wall, and two spaced upper wings which are vertically extended from the horizontal lower wedge and support the rolling rollers therebetween; the movable semi-guide is formed by a second profile, comprising an upper wing fixed above to the inner face of the openable glass door and provided with the contact track below.

Preferably, the museum display case comprises coupling means for constraining the movable semi-guide to the fixed semi-guide so that the movable semi-guide is free to slide horizontally with respect to the fixed semi-guide but is not free to be raised with respect to the fixed semi-guide. The anti-raising constraint ensures that the openable glass door cannot be raised and that unauthorised access to the inside of the display case is therefore not possible. In addition, this constraint also prevents the openable glass door from tilting when it is opened more than about 50%.

Preferably, the coupling means comprise a longitudinal seat formed in the lower wedge of the first profile and a lower wing of the second profile joined to the upper wing by an intermediate wing; the lower wing of the second profile is in horizontal sliding engagement in the seat of the first profile. This configuration ensures effective restraint in the vertical direction, preventing the openable glass door from raising, and also improves the precision of the guide in the horizontal direction.

Preferably, the seat of the first profile is open towards the outside of the museum display case, the intermediate wing of the second profile is extended towards the outside of the museum display case, and the lower wing of the second profile faces the inside of the museum display case. This configuration is preferred because it allows the upper wing of the first profile to be facing the inside of the display case, thus enabling the attachment of accessories inside the display case, such as lighting fixtures.

Preferably, the museum display case comprises an auxiliary stand, comprising a base surmounted by a support structure to receive the openable glass door when opened beyond a preset limit. This auxiliary stand, placed at a suitable distance from the display case, provides support for the openable glass door as it is opened, allowing the display case to be opened even up to almost 100%.

Preferably, the support structure of the auxiliary stand comprises at least one upper roller, so that the openable glass door slides precisely and without creeping.

### BRIEF DESCRIPTION OF THE DRAWINGS

Further characteristics and advantages of a museum display case according to the present disclosure will become clearer from the following description of a preferred embodiment thereof, made with reference to the appended drawings. In such drawings:

FIG. 1 is a schematic perspective view of a museum display case according to the disclosure;

FIG. 2 is a schematic perspective view of the museum display case of FIG. 1, provided with auxiliary stand;

FIG. 3 is an enlarged-scale vertical cross-sectional view of a detail of the display case of FIG. 1;

FIG. 4 is an enlarged-scale vertical cross-sectional view of a detail of the display case of FIG. 1.

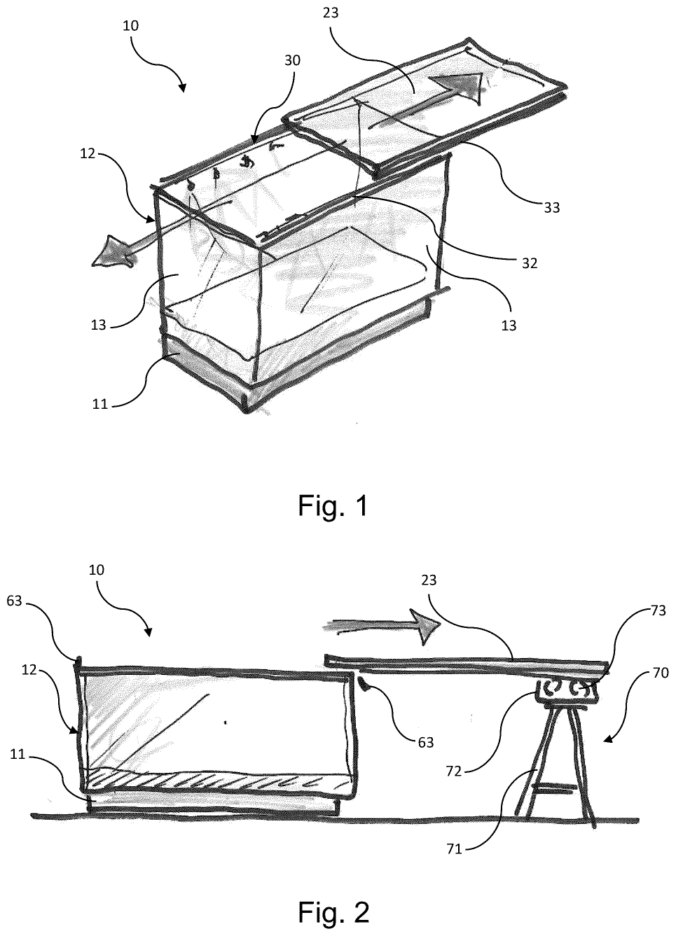

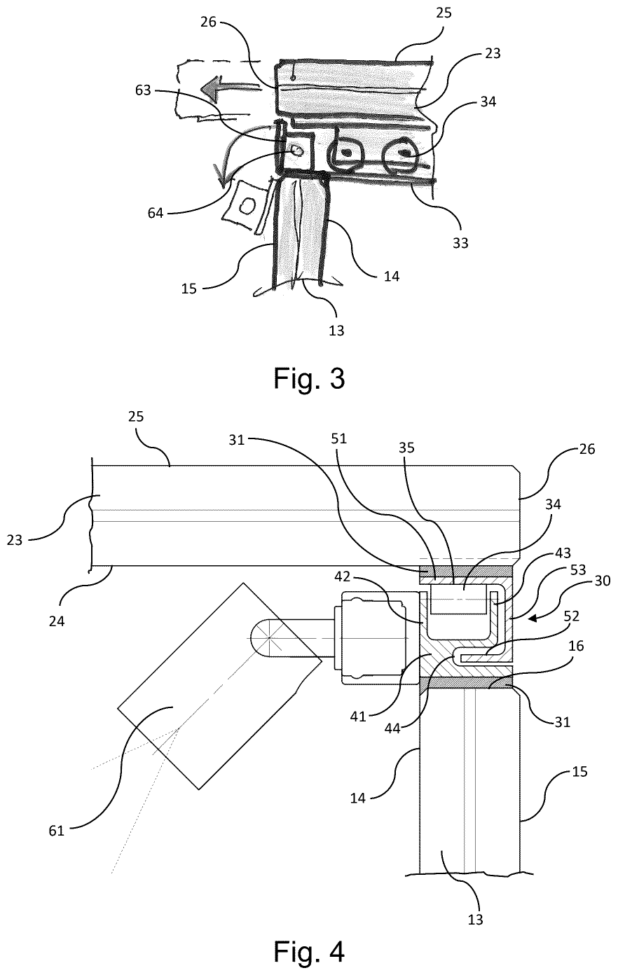

### DETAILED DESCRIPTION

A museum display case 10 in accordance with several embodiments of the present disclosure, of the so-called table-top type, is shown schematically in the figures. The display case 10 comprises a base 11 surmounted by a fixed case 12, formed by four fixed vertical glass walls 13 joined together at their respective vertical edges, e.g. and preferably by bonding with a suitable structural adhesive (not shown in the figures). The fixed glass walls 13 have respective inner faces 14, facing inwards from the display case 10 and respective outer faces 15, facing outwards from the display case 10; the inner faces 14 are connected to the outer faces 15 by peripheral edges 16.

The fixed case 12 is closed above by an openable glass door 23, which is either horizontal or slightly inclined, slidingly openable with respect to the fixed case 12. The openable glass door 23 comprises an inner face 24 facing downwards and thus inwards from the display case 10, an outer face 25 facing upwards and thus outwards from the display case 10, as well as peripheral edges 26 connecting the inner face 24 and the outer face 25.

Preferably, the fixed glass walls 13 as well as the openable glass door 23 are made as multi-layers, with at least two glass sheets coupled by means of suitable adhesives.

The display case 10 comprises two horizontal linear guides 30, between the openable glass door 23 and the fixed glass wall 12, more specifically between the openable glass door 23 and two opposite fixed glass walls 13.

Each linear sliding guide 30 is applied, on one side, to the inner face 24 of the openable glass door 23, close to one of its peripheral edges 26, on the other side exactly on the peripheral edge 16 of the fixed glass wall 13. The application of the linear sliding guides 30 is preferably achieved with a suitable adhesive, e.g. of the structural type, indicated with 31 in the figures.

More specifically, each linear sliding guide 30 comprises a fixed lower semi-guide 32 and a movable upper semi-guide 33. The fixed semi-guide 32 comprises rolling rollers 34, parallel and facing upwards, which are in rolling engagement on a contact track 35 facing downwards formed on the movable semi-guide 33, so that the movable semi-guide 33 is movable longitudinally with respect to the fixed semi-guide 32. Alternatively, according to a variant not shown, the fixed semi-guide and the movable semi-guide can comprise respective low sliding friction contact tracks.

The fixed semi-guide 32 is formed of a first profile, which comprises a horizontal lower wedge 41, which is fixed below to the peripheral edge 16 of the fixed glass wall 13, and two upper wings 42 and 43, respectively inner (i.e. facing inwards from the display case 10) and outer (i.e. facing outwards from the display case 10).

The two wings 42 and 43 are parallel and spaced apart; they extend vertically from the horizontal lower wedge 41 and support the rolling rollers 34 therebetween. In the lower wedge 41, a horizontal seat 44 is formed, extending longitudinally along the fixed semi-guide 32.

The movable semi-guide 33 is formed by a second profile, which comprises a horizontal upper wing 51, which is extended longitudinally along the entire movable semi-guide 33 and is fixed above to the inner face 24 of the openable glass door 23, the upper wing 51 is provided with the contact track 35 below. The movable semi-guide 33 also comprises a horizontal lower wing 52 joined to the upper wing 51 by a vertical intermediate wing 53. The lower wing 52 of the movable semi-guide 33 is in horizontal sliding engagement in the seat 44 of the fixed semi-guide 32.

The lower wing 52 of the movable semi-guide 33 and the seat 44 of the fixed semi-guide 32 form coupling means for constraining the movable semi-guide 33 to the fixed semi-guide 32 so that the movable semi-guide 33 is free to slide horizontally with respect to the fixed semi-guide 32 but is not free to be raised with respect to the fixed semi-guide 32.

Preferably, the seat 44 is open towards the outside of the museum display case 10, while the intermediate wing 53 is extended towards the outside of the museum display case 10, as well as the lower wing 52 is facing the inside of the museum display case 10, as clearly visible in FIG. 4.

The upper wing 42 is facing the inside of the display case 10; it can therefore usefully be used to mount internal accessories of the display case 10, such as lighting fixtures 61.

An inverted arrangement (not preferred and not illustrated) is also possible, wherein the seat is open towards the inside of the display case, the intermediate wing is extended towards the inside of the display case, and the lower wing is facing the outside of the display case. This arrangement can be adopted when there is no need for light fixtures or other accessories, and it is therefore not necessary to have the upper wing facing the inside of the display case.

The linear sliding guides 30 have dimensions substantially corresponding to the thickness of the fixed glass wall 13 to which they are applied. Thus, as visible in FIG. 4, the upper wing 42 of the fixed semi-guide 32 is substantially coplanar to the inner face 14 of the fixed glass wall 13, and the intermediate wing 53 of the movable semi-guide 33 is substantially coplanar to the outer face 15 of the fixed glass wall 13. There is therefore no protrusion from the faces of the fixed glass walls 13 and for this reason the linear sliding guides 30 are little visible: they appear in practice as a kind of thin frame, which closes the fixed glass walls 13 at the top. Observing the display case 10 from above, as is normally the case with this type of display cases, the sliding guides 31 are practically invisible.

The display case 10 can be opened by horizontally sliding the openable glass door 23 with respect to the fixed case 12, in either direction.

To ensure that the display case 10 can only be opened by authorised personnel, a door 63 can be provided with a lock 64 at one or both ends of the fixed semi-guide 32.

With the door 63 closed, the movable semi-guide 33 cannot slide with respect to the fixed semi-guide 32 and therefore the openable glass door 23 cannot be opened.

Preferably, then, as shown in FIG. 2, the museum display case 10 comprises an auxiliary stand 70, separated from the base 11 and the fixed case 12 and placed at a preset distance. The auxiliary stand 70 comprises a base 71 surmounted by a support structure 72, provided with two upper rollers 73. The auxiliary stand 70 is positioned and dimensioned in such a way that the openable glass door 23—during its opening—rests on the rollers 73, remaining substantially horizontal; the weight of the openable glass door 23 therefore partly rests on the fixed case 12, partly on the auxiliary stand 70, thus avoiding dangerous mechanical stresses on the linear sliding guides 30, in particular on the wings 52 engaged in the seats 44.

The auxiliary stand 70 can be equally placed on one side or the other of the display case 10, depending on which direction you prefer to open the openable glass door 23. It is also possible to provide two auxiliary stands 70, on either side of the display case 10, should you wish to be able to open the openable glass door 23 on either side, indifferently.

1. A table-top museum display case, comprising
a fixed case formed by fixed glass walls surmounted by an upper openable glass door, which is slidingly openable with respect to the fixed case, wherein the fixed glass walls and the openable glass door have, with respect to the display case, respective inner faces and outer faces connected by peripheral edges, and
two linear sliding guides between the openable glass door and the fixed case, wherein the linear sliding guides are applied i) on one side on an inner face of the openable glass door near opposite peripheral edges of the openable glass door and ii) on the other side on peripheral edges of two opposite sides of the fixed glass walls, the linear sliding guides having dimensions corresponding to a thickness of the fixed glass wall to which they are applied.

2. The museum display case according to claim 1, wherein each of the two linear sliding guides comprises
a fixed semi-guide fixed to the peripheral edge of one of the fixed glass walls and
a movable semi-guide fixed to the inner face of the openable glass door.

3. The museum display case according to claim 2, wherein
the fixed semi-guide comprises rolling rollers and
the movable semi-guide comprises a contact track resting on the rolling rollers.

4. The museum display case according to claim 2, wherein the fixed semi-guide and the movable semi-guide comprise respective low sliding friction contact tracks.

5. The museum display case according to claim 3,
wherein the fixed semi-guide is formed by a first profile, comprising i) a lower wedge fixed below to the peripheral edge of the fixed glass wall and ii) two spaced upper wings which are vertically extended from the lower wedge and support the rolling rollers therebetween, and
wherein the movable semi-guide is formed by a second profile, said second profile comprising an upper wing fixed above to the inner face of the openable glass door and said second profile being provided with the contact track below.

6. The museum display case according to claim 5, comprising
coupling means for constraining the movable semi-guide to the fixed semi-guide so that the movable semi-guide is free to slide horizontally with respect to the fixed semi-guide but is not free to be raised with respect to the fixed semi-guide.

7. The museum display case according to claim 6,
wherein the coupling means comprise a longitudinal seat formed in the lower wedge of the first profile and a longitudinal lower wing of the second profile joined to the upper wing by an intermediate wing, and
wherein the lower wing of the second profile is in horizontal sliding engagement in the seat of the first profile.

8. The museum display case according to claim 7,
wherein the seat of the first profile is open towards the outside of the museum display case,
wherein the intermediate wing of the second profile is extended towards the outside of the museum display case and
wherein the lower wing of the second profile is facing the inside of the museum display case.

9. The museum display case according to claim 1, further comprising an auxiliary stand, the auxiliary stand comprising a base surmounted by a support structure for supportingly accommodating the openable glass door when open beyond a preset limit.

10. The museum display case according to claim 2, comprising
coupling means for constraining the movable semi-guide to the fixed semi-guide so that the movable semi-guide is free to slide horizontally with respect to the fixed semi-guide but is not free to be raised with respect to the fixed semi-guide.
